(19) United States
(12) Patent Application Publication
(10) Pub. No.: US 2017/0090936 A1
(43) Pub. Date: Mar. 30, 2017

(54) METHOD AND APPARATUS FOR DYNAMICALLY TUNING SPECULATIVE OPTIMIZATIONS BASED ON INSTRUCTION SIGNATURE

(71) Applicant: QUALCOMM Incorporated, San Diego, CA (US)

(72) Inventors: Rami Mohammad AL SHEIKH, Raleigh, NC (US); Shivam PRIYADARSHI, Raleigh, NC (US)

(21) Appl. No.: 15/087,728

(22) Filed: Mar. 31, 2016

Related U.S. Application Data
(60) Provisional application No. 62/232,488, filed on Sep. 25, 2015.

(51) Int. Cl. G06F 9/38; G06N 7/00; G06F 9/30

(52) U.S. Cl. CPC G06F 9/3838; G06F 9/30145; G06N 7/005

(57) ABSTRACT

A method for instruction signature based (ISB) speculative optimization includes storing a plurality of entries. Each entry of the plurality of entries includes an instruction signature tag and an ISB predictor effectiveness measurement. The instruction signature tag corresponds to an instruction signature and the ISB predictor effectiveness measurement is based, least in part, on an effectiveness of a predictor when applied to the instruction signature. The method also includes detecting a to-be-executed instruction signature and determining if the plurality of entries includes a matching entry. The matching entry has an instruction signature tag corresponding to the to-be-executed instruction signature. Upon determining that the plurality of entries includes the matching entry, the method includes controlling an application of the predictor to the to-be-executed instruction signature, based at least in part on the ISB predictor effectiveness measurement in the matching entry.

### CROSS-REFERENCE TO RELATED APPLICATION

The present application for patent claims the benefit of U.S. Provisional Application No. 62/232,488, entitled “METHOD AND APPARATUS FOR DYNAMICALLY TUNING SPECULATIVE OPTIMIZATIONS BASED ON INSTRUCTION SIGNATURE,” filed Sep. 25, 2015, assigned to the assignee hereof, and expressly incorporated herein by reference in its entirety.

### FIELD OF DISCLOSURE

The disclosure pertains to programmable processing and, more particularly, to speculative optimization.

### BACKGROUND

In the field of programmable processing, speculative optimization is a run-time technique that, instead of delaying execution of an instruction until its operand values are fixed, or the instruction's triggering event performs the instruction early, using predicted operand values or predicted occurrence of the triggering event. Benefits can include, for example, reducing processor idle time that might otherwise be wasted waiting for calculation of operands. Other benefits can include reducing memory access overhead by prefetching data and instructions for execution of a branch instead of waiting for the requisite branching decision, by which time prefetching may have less benefit.

The above-identified benefits, and others, however, are only obtained when the predictions are correct. When a prediction is incorrect, costs are incurred. Example costs include misprediction recovery. Various conventional techniques for misprediction recovery are known to persons of skill, but, in general, such recovery techniques discard the processing that was performed in reliance on the prediction, and goes back and picks up the instruction sequence where it would have been absent the incorrect prediction. The recovery expends resources.

There are known, conventional techniques for tracking accuracy of speculation and, based on the tracking, disabling or inhibiting the speculation. However, such conventional techniques can have costs such as global disabling or inhibiting speculation in response to inaccuracy occurring only in specific contexts.

### SUMMARY

Methods are disclosed that can provide instruction signature based speculative optimization. In an aspect, a method for instruction signature based (ISB) speculative optimization includes storing a plurality of entries. Each entry of the plurality of entries includes an instruction signature tag and an ISB predictor effectiveness measurement. The instruction signature tag corresponds to an instruction signature and the ISB predictor effectiveness measurement is based, least in part, on an effectiveness of a predictor when applied to the instruction signature. The method also includes detecting a to-be-executed instruction signature and determining if the plurality of entries includes a matching entry. The matching entry has an instruction signature tag corresponding to the to-be-executed instruction signature. Upon determining that the plurality of entries includes the matching entry, the method includes controlling an application of the predictor to the to-be-executed instruction signature, based at least in part on the ISB predictor effectiveness measurement in the matching entry.

In another aspect, an apparatus for instruction signature based (ISB) speculative optimization includes means for storing a plurality of entries. Each entry of the plurality of entries including an instruction signature tag and an ISB predictor effectiveness measurement. The instruction signature tag is a mapping of an instruction signature, and the ISB predictor effectiveness measurement indicates an effectiveness of a predictor when applied to the instruction signature. The apparatus also includes means for detecting a to-be-executed instruction signature having a matching entry among the plurality of entries. Further included in the apparatus is a means for controlling a predictor as applied to the to-be-executed instruction signature, based at least in part on the ISB predictor effectiveness measurement in the matching entry.

In yet another aspect, a non-transitory computer readable medium including code is provided. When the code is read and executed by a processor, it causes the processor to: (i) store a plurality of entries, each entry of the plurality of entries including an instruction signature tag and an ISB predictor effectiveness measurement, the instruction signature tag corresponding to an instruction signature, and the ISB predictor effectiveness measurement indicating an effectiveness of a predictor when applied to the instruction signature; (ii) detect a to-be-executed instruction signature; (iii) determine if the plurality of entries includes a matching entry, the matching entry having an instruction signature tag corresponding to the to-be-executed instruction signature; and (iv) control an application of the predictor to the to-be-executed instruction signature, based at least in part on the ISB predictor effectiveness measurement in the matching entry.

In a further aspect, an apparatus for instruction signature based (ISB) speculative optimization includes a processor and a memory coupled to the processor. The processor is configured to: (i) store a plurality of entries, each entry of the plurality of entries including an instruction signature tag and an ISB predictor effectiveness measurement, the instruction signature tag corresponding to an instruction signature, and the ISB predictor effectiveness measurement indicating an effectiveness of a predictor when applied to the instruction signature, (ii) detect a to-be-executed instruction signature, (iii) determine if any of the plurality of entries is a matching entry for the to-be-executed instruction signature, and (iv) control an application of the predictor to the to-be-executed instruction signature, based at least in part on the ISB predictor effectiveness measurement in the matching entry.

### BRIEF DESCRIPTION OF THE DRAWINGS

The accompanying drawings are presented to aid in the description of aspects, and exemplary practices according to the aspects, and are provided solely for illustration of the embodiments and not limitation thereof.

FIG. 1 is a high level block diagram of an example system configured to provide instruction signature based (ISB) dynamically tuned speculative optimization according to various aspects.

FIG. 2 is a graphical illustration that shows an example configuration of an ISB predictor effectiveness table, in accordance with various aspects.

FIG. 3 is a diagram of an ISB control of a predictor in an ISB dynamically tuned speculative optimization process according to various aspects.

FIG. 4A is a diagram of an example flow of operations in a process of ISB dynamically tuned speculative optimization, according to various aspects.

FIG. 4B is a diagram of an example flow of operations in a process of ISB dynamically tuned speculative optimization, according to various aspects.

FIG. 5 is a functional schematic of one example personal communication and computing device in accordance with one or more aspects.

### DETAILED DESCRIPTION

Example devices, methods, system and operations according to various aspects are disclosed in the following description and related drawings. Alternatives may be devised without departing from disclosed concepts. Additionally, well-known elements will not be described in detail or will be omitted so as not to obscure the relevant details of the invention.

The word “exemplary” is used herein to mean “serving as an example, instance, or illustration.” Any implementation or variation described herein as “exemplary” is not necessarily to be construed as preferred or advantageous over other implementations and variations therefore.

The terminology used herein is for the purpose of describing particular implementations and operations only and is not intended to be limiting of any aspect. As used herein, the singular forms “a”, “an” and “the” are intended to include the plural forms as well, unless the context clearly indicates otherwise. It will be understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, methods and processes according to various aspects may be described, at least in part, in terms of sequences of actions performed by, for example, a particularly configured computing device, or portions of one or more of such devices. It will be recognized that various actions described herein can be performed by specific circuits (e.g., application specific integrated circuits (ASICs)), by program instructions being executed by one or more processors, or by a combination of both. Additionally, sequences of actions described herein can be considered to be embodied entirely within any form of computer readable storage medium having stored therein a corresponding set of computer instructions that upon execution would cause an associated processor to perform the functionality described herein. Thus, the various aspects may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The term “instruction,” as used in this disclosure, can be a machine-executable instruction, for example, that is or can be retrievably stored in any machine-readable medium.

The terms “type of predictor” and “predictor type,” as used in this disclosure, are interchangeable, and mean the kind of future value, future state, future action or decision that the predictor predicts. Data value predictors, branch predictors, and pre-fetch predictors are, respectively, examples of three different types of predictors, or predictor types.

The term “speculative optimization,” as used in this disclosure, means optimizing a performance or efficiency of a processing resource relying on prediction of a future value or future state of a variable, or on a future conditional action or conditional decision, for which the value(s) or state(s) of the determining conditions are not presently known. Examples include, without limitation, performing operations using, as one or more data operands, predicted data values for the operands. Examples further include, without limitation, prefetching instructions or data for a branch, or executing instructions in the branch, or both, based on a predicted likelihood that the branch will be chosen or selected.

The term “instruction signature,” as used in this disclosure, means a static property of an instruction, where “static” means encoded in the instruction and not subject to change during program execution. One example instruction signature can be an opcode of an instruction (e.g., register move, ADD, “if-then-else” branch decision), augmented by bits from the instruction encoding, for example, register numbers. An arbitrary first specific example instruction signature can be opcode bits for a register load of a first target register. These comprise opcode bits of “register load” and opcode bits for the name of the first target register. An arbitrary second specific example instruction signature can be opcode bits for a register load of a second target register. These can comprise, as with the arbitrary first specific example instruction signature, opcode bits of “register load,”, but with opcode bits for the name of the second target register.

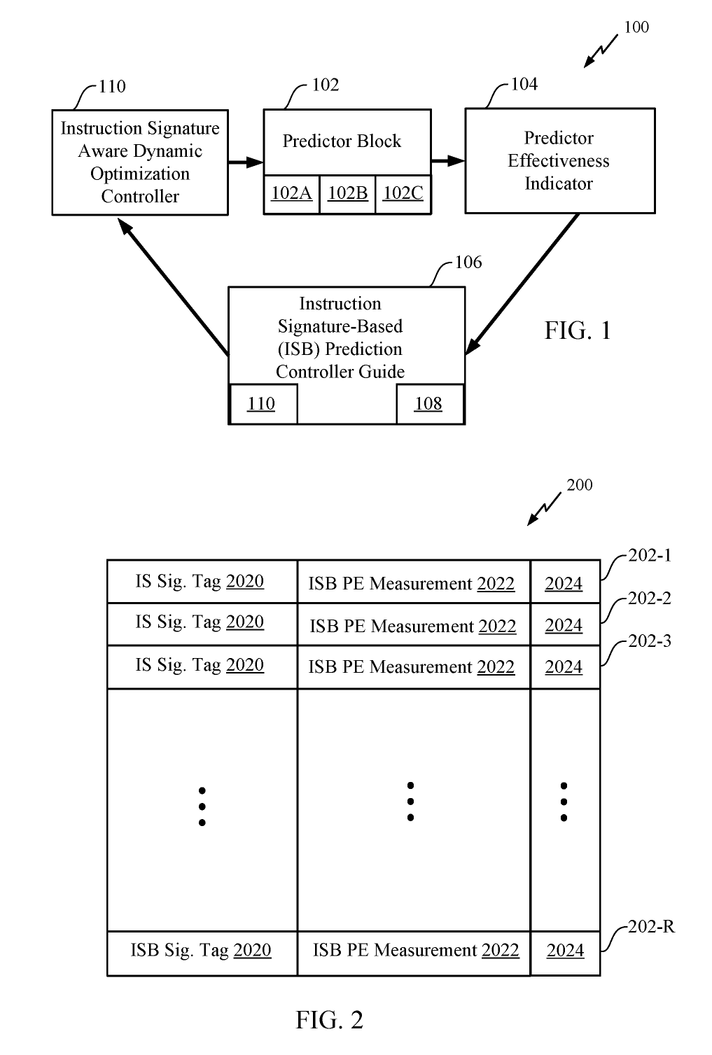

FIG. 1 is a functional block diagram of one system 100 that is configured to provide ISB (Instruction Signature-Based) dynamically tunable speculative optimization to various aspects. In an aspect, system 100 can include a predictor block 102, a predictor effectiveness indicator 104, an ISB prediction controller guide 106 comprising a table 108, and a control logic 110, and can include an instruction signature aware dynamic optimization controller 112. The system 100 may be a feature of a larger programmable processor system (not explicitly visible in FIG. 1), as described in further detail later in this disclosure.

Referring to FIG. 1, the predictor block 102 may comprise, for example, a data value predictor 102A. The data value predictor 102A can be configured to predict a data value that that will be loaded into a target register by a register load instruction. In an aspect, the predictor block 102 can comprise a branch predictor 102B, either as alternative to or in combination with the data value predictor 102A. In another aspect, the predictor block 102 can comprise a pre-fetch predictor 102C, either alone or in addition to the data value predictor 102A, or the branch predictor 102B or both.

Referring to FIG. 1, in a general aspect, the predictor effectiveness indicator 104 can be configured to initialize and maintain during execution of a program, a predictor effectiveness measurement for each predictor type provided by the predictor block 102. For example, if the predictor block 102 is configured with the data value predictor 102A, the predictor effectiveness indicator 104 can be configured with a data value predictor effectiveness indicator (not visible in FIG. 1). The data value predictor effectiveness indicator may be configured to calculate predictor effectiveness measurement as a “miss ratio,” which is a ratio of the number of mispredictions to the total number of predictions. The miss ratio functionality of the data value predictor effectiveness indicator can be provided, for example, by a total prediction counter (not separately visible in FIG. 1) and a misprediction counter (not separately visible in FIG. 1). As will be described in greater detail later, the predictor effectiveness indicator 104 can be configured to receive “hit/miss” notices from the processor associated with the system 100.

If the predictor block 102 is configured to include the branch predictor 102B, the predictor effectiveness indicator 104 can be configured to include a branch predictor effectiveness indicator (not visible in FIG. 1. The branch predictor effectiveness indicator can be implemented, for example, with counters (not visible in FIG. 1) that, similar to the example data value predictor effectiveness indicator 104A, count total branch predictions and mispredictions. If the predictor block 102 is configured with the pre-fetch predictor 102C, predictor effectiveness indicator 104 may be configured with a pre-fetch predictor effectiveness indicator (not visible in FIG. 1), which may be based on prefetch accuracy (the ratio of a number of useful prefetches to a total number of prefetches) or timeliness (the ratio of a number of prefetches that were able to provide data in time to service a demand request to a total number of prefetches).

Referring to FIG. 1, in an aspect, the table 108 can be configured to retrievably store a plurality of ISB predictor effectiveness entries (not visible in FIG. 1), which are described in greater detail later in this disclosure. In an aspect, control logic 110 can be provided. The block representing the control logic 110 is shown within the block representing the ISB prediction controller guide 106. It will be understood that the position of the control logic 110 is to present a logical association, and is not a limitation on the configuration(s), location(s), or arrangement(s) of the hardware or other processing resources that can implement the control logic 110, The ISB control logic 110 can be configured to control access to the ISB predictor effectiveness table 108 and, for example, to perform operations in processes of validating, invalidating, initializing and clearing ISB predictor effectiveness entries, as described in greater detail later.

The instruction signature aware dynamic optimization controller 112 may include a comparator logic for comparing ISB predictor effectiveness measurements from the ISB prediction controller guide 106 to a predictor control criterion (e.g., a misprediction rate threshold) (not separately visible in FIG. 1). In an aspect, the instruction signature aware optimization controller 112 may be configured to control the utilization of predictors based on the comparison.

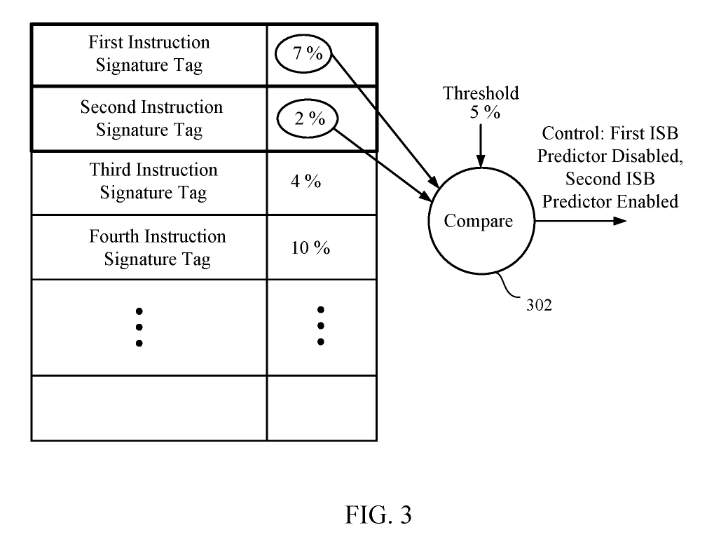

FIG. 2 shows an exemplary ISB predictor effectiveness entry table 200, which can be an example implementation of the FIG. 1 table 108. The ISB predictor effectiveness entry table 200 and the control logic 110 can be a means for retrievably storing a plurality of ISB predictor effectiveness entries. The ISB predictor effectiveness entry table 200 is shown in an exemplary state storing a population R of ISB predictor effectiveness entries, comprising ISB predictor effectiveness entries 202-1, 202-2 . . . 202-R. For brevity, the R ISB predictor effectiveness entries will be collectively referenced as “ISB predictor effectiveness entries 202” (a label not separately appearing in FIG. 2).

Each of the ISB predictor effectiveness measurement entries 202 can comprise an instruction signature tag 2020 and an ISB predictor effectiveness measurement 2022. In an aspect, each ISB predictor effectiveness measurement entry 202 can also comprise a validity flag 2024.

In an aspect, each instruction signature tag 2020 can be a mapping of a corresponding instruction signature. Regarding configurations and formats of the instruction signature tag 2020, one example can be a copy of an opcode (not explicitly visible in FIG. 2) for an instruction signature. As another example, the instruction signature tag 2020 may be a mapping, for example a hash, of an instruction signature. The instruction signature tags 2020 may also be a copy, or mapping (e.g., hash), of added signature identifier bits (not visible in the figures), for example, appended to selected instruction signatures within a program, prior to execution. In another example, the instruction signature can be a copy of, or a mapping (e.g., hash) of selected bit positions (not explicitly visible in FIG. 2) within the opcode for the instruction signature, as opposed to the entire instruction signature. For reference within this description the selected bit positions will be arbitrarily named “instruction signature ID bits.” Since the number of instruction signature ID bits is lower than the number of bits forming the entire instruction signature, benefits can include reduced hardware complexity of the mapping logic.

Selecting which bits of the instruction signature to use as instruction signature ID bits can be based in part on uniqueness of the selected bits to the different instruction signatures. As an illustration, assume a first instruction signature as being a load of a first register, and a second instruction signature being a load of a second register. The instruction signature ID bits can be, for example, a minimum or near-minimum subset of opcode bits unique to the register load instruction, together with a minimum subset of opcode bits that are both unique to the first register and to the second register. Regarding the quantity of bits forming the instruction signature ID bits, one consideration is that the quantity, which may be termed “N,” may establish the maximum population of different ISB predictor effectiveness measurement entries 202 that can be retrievably stored in the SB predictor effectiveness entry table 200. More specifically, the maximum population of different ISB predictor effectiveness measurement entries 202 can be the numeric value two raised to the N^{th} power. For example, if N is four there can be a maximum of sixteen different ISB predictor effectiveness measurement entries 202.

Example operations in one or more processes according to various aspects will be described. Assumptions will be stated first, to further assist in understanding illustrated concepts. Operational assumptions are the FIG. 2 ISB predictor effectiveness measurement entry 202-1 being a first entry, and ISB predictor effectiveness measurement entry 202-2 being a second entry. A first register and a second register will be assumed, which will be referred to as “R0” and “R1.” It will be assumed that an instruction to load the second register, R0, with data at a memory address stored in a first specified register to be a first program instruction to which ISB dynamically tuned speculative optimization according to various aspects will be applied. It will be assumed that an instruction to load the second register, R, with data at a memory address stored in a second specified register to be a second program instruction to which ISB dynamically tuned speculative optimization according to various aspects will be applied.

Continuing with the above example, it will be assumed that the first program instruction can be represented by a first assembler code statement, such as “LDR R0, 0(R3).” This representation is for purpose of illustration, and is not intended to limit the scope of any aspect. In the example representation, “LDR” can be the assembler code form of the register load instruction, and “R0” can be the destination register, and “R3” can identify the first specified register holding the memory address of the data to load into R0. The second program instruction can be represented, for purposes of description, by a second assembler code statement, such as “LDR R1, 0(R1).” This differs from the first assembler code statement in that the destination register is R1, and the second specified register holding the memory address of the data to load into R1 is “R3.” The opcode for the load register instruction, in both the first program instruction and the second program instruction, can be represented, for purposes of description, as “LDR [symbol] 0101.” The opcode bits identifying R0 can be assumed as “00,” and the opcode bits identifying R1 can be assumed as “01.”

Continuing with description of the above example, a first instruction signature can comprise opcode bits for the load register instruction, which are “0101,” together with the opcode bits identifying R0 as the destination register. The first instruction signature can be represented as “LDR [symbol] 010100.” The second instruction signature can be of similar form, but having the opcode bits identifying R1 as the destination register. The second instruction signature can therefore be represented as “LDR [symbol] 010101.”

Lastly, assume that the processor (not visible in FIGS. 1 and 2) is configured with a detection logic (not visible in FIGS. 1 and 2) further configured to recognize, for example in an instruction fetch buffer or upper pipeline of the processor, or elsewhere, a set of instruction signatures to which ISB dynamically tuned speculative optimization will be applied according to various aspects. Assume that the first instruction signature and the second instruction signature that are described above can be recognized by the detection logic.

Example operations will now be described. An initial operation can include a clearing of the table 108, for example, by specific program instructions. Referring to FIG. 2, example actions in the clearing operation can include setting, to an invalid state, the validity flags 2024 of all ISB predictor effectiveness measurement entries 202 in the ISB predictor effectiveness entry table 200. A starting event can be a first detection of the first instruction signature, namely, “LDR [symbol] 010100.” In response, the FIG. 1 control logic 110 can search the ISB predictor effectiveness entry table 200 (the assumed implementation of the table 108) for an ISB predictor effectiveness measurement entry 202 having, as its instruction signature tag 2020, bits forming the first instruction signature “LDR [symbol] 010100.” The ISB predictor effectiveness entry table 200, having been initialized, will have no valid ISB predictor effectiveness measurement entry 202. Accordingly, a valid ISB predictor effectiveness measurement entry 202, for the first instruction signature, can be instantiated. For purposes of description, the entry will be assumed to be the first ISB predictor effectiveness measurement entry 202-1.

Example operations in the instantiation of the valid ISB predictor effectiveness measurement entry 202 for the first instruction signature can include loading the ISB predictor effectiveness measurement 2022 of the first ISB predictor effectiveness measurement entry 202-1 with a starting value. The starting value can be the initial value of the ISB predictor effectiveness measurement for the first instruction signature that is provided to the instruction signature aware optimization controller 112, for controlling application of the data value predictor 102A to that instruction signature. Operations of instantiating the first ISB predictor effectiveness measurement entry 202-1, for the first instruction signature, can include setting the valid flag 2024 of 202-1 to a valid value, e.g., logical “1.”

Associated with instantiating the first ISB predictor effectiveness measurement entry 202-1, the data value predictor 102A can be applied to the instruction as defined by the first instruction signature. In an aspect, associated with application of the data value predictor 102A two counters can be incremented. The first counter can be the total predictions counter in the predictor effectiveness indicator 104 for the data value predictor 102A (i.e., a counter that tracks effectiveness for all data value predictions). The other counter can be a total predictions counter maintained, for example, by the control logic 110, for calculating the ISB predictor effectiveness measurement 2022 of the just-instantiated first ISB predictor effectiveness measurement entry. After latency, the data value prediction generated by the data value predictor 102A is resolved as a hit or a miss. If the data value prediction is resolved as a hit, the ISB predictor effectiveness measurement 2022 of the first ISB predictor effectiveness measurement entry 202-1 is left at its starting value described above Also, the predictor effectiveness measurement for the data value predictor 102A that is maintained by the predictor effectiveness indicator 104 can be left unchanged.

Continuing with the example, if the prediction is resolved as miss, the ISB predictor effectiveness measurement 2022 of the first ISB predictor effectiveness measurement entry 202-1 is adjusted. The adjustment can comprise, for example, incrementing a miss counter that is maintained by the control logic 110, also for calculating the ISB predictor effectiveness measurement 2022 of the just-instantiated first ISB predictor effectiveness measurement entry. Also, the predictor effectiveness measurement described above which the predictor effectiveness indicator 104 maintains for the data value predictor 102A is adjusted.

It will be assumed that a next event is a first detection of the second instruction signature. In response, a second entry can be instantiated. The instantiation can be as described above for the first ISB predictor effectiveness measurement entry 202-1. The first application of the data value predictor 102A to the instruction as defined by the first instruction signature will be assumed to be a hit.

Assume a sequence of next events that includes detection of a plurality of instances of the first instruction signature and a plurality of instances of the second instruction signature. Assume, for purposes of example, a numeral value 100 as the number of instances of the first instruction signature, and a numeral value 150 as the number of instances of the second instruction signature. Assume that at each detected instance of the first instruction signature, the first ISB predictor effectiveness measurement entry 202-1 is accessed, and its ISB predictor effectiveness measurement 2022 is adjusted, depending on whether the application of the data value predictor 102A is correct. Assume also that the predictor effectiveness measurement that the predictor effectiveness indicator 104 maintains for the data value predictor 102A is adjusted, depending on whether the application of the data value predictor value 102A is correct. Assume that at each detected instance of the second instruction signature, the second ISB predictor effectiveness measurement entry 202-2 is accessed, and its ISB predictor effectiveness measurement 2022 is adjusted, depending on whether the application of the data value predictor 102A is correct. In addition, assume that that the predictor effectiveness measurement that the predictor effectiveness indicator 104 maintains for the data value predictor 102A is adjusted, depending on whether the application of the data value predictor 102A is correct.

Continuing with the example, assume numeral value 5 misses resulted from the numeral value 100 applications of the data value predictor 102A to the instances of program instructions having the first instruction signature. The result will be the ISB predictor effectiveness measurement 2022 of the first ISB predictor effectiveness measurement entry 202-1 being adjusted 100 times, of which numeral value 95 are adjustments that reflect a hit, and numeral value 5 are adjustments that reflect a miss. In an aspect, the adjustments that reflect a hit can exploit an update signal (not explicitly visible in the figures) that the predictor effectiveness indicator may output (or receive) in associated with each miss. In terms of miss ratio, the ISB predictor effectiveness measurement 2022 of the first entry ISB predictor effectiveness measurement entry 202-1 is 5%.

Assume that, in contrast, numeral value 28 misses resulted from the numeral value 150 applications of the data value predictor 102A to the instances of program instructions having the second instruction signature. The result will be the ISB predictor effectiveness measurement 2022 of the second ISB predictor effectiveness measurement entry 202-2 being adjusted 150 times, of which numeral value 122 are adjustments that reflect a hit, and numeral value 28 are adjustments that reflect a miss. In terms of miss ratio, the ISB predictor effectiveness measurement 2022 of the second entry 202-2 is approximately 18.66%.

As described above, the predictor effectiveness indicator 104 does not discriminate between applications of the data value predictor 102A to the first instruction signature and applications of the data value predictor 102A to the second instruction signature. Accordingly, at each instance of the first instruction signature, and at each instance of the second instruction signature, the predictor effectiveness measurement that the predictor effectiveness indicator 104 maintains for the data value predictor 102A is adjusted, in a direction that reflects whether that application of the data value predictor 102A is a hit or a miss. The predictor effectiveness measurement that the predictor effectiveness indicator 104 maintains for the data value predictor 102A is therefore adjusted numeral value 250 times, of which numeral value 217 are adjustments that reflect a hit, and numeral value 33 are adjustments that reflect a miss. In terms of miss ratio, the predictor effectiveness measurement that the predictor effectiveness indicator 104 maintains for the data value predictor 102A is 13.2%.

It will be understood that control of the data value predictor 102A based on the predictor effectiveness indicator 104, as applied to the program instructions having the first instruction signature or the second instruction signature, can be disabled. It can also be assumed that control of the data value predictor 102A, based on the predictor effectiveness indicator 104, for program instructions not according to the first instruction signature or the second instruction signature, and not according to any other instruction signature, can be according to known, conventional techniques.

Example operations of control of the data value predictor 102A, according to aspects of ISB dynamically tuned speculative optimization, will now be described. In an aspect, at each detection of the first instruction signature operations are applied that map the first instruction signature to the instruction signature tag 2020 of the first ISB predictor effectiveness measurement entry 202-1. The specific operations can depend, in part, on the implementation of the ISB predictor effectiveness entry table 200. For example, if the ISB predictor effectiveness entry table 200 is implemented by a content-addressable memory (CAM), using the instruction signature tag as the index, operations can include searching the CAM using the first instruction signature. The searching may utilize, for example, instruction identifier bits (if used) of the first instruction signature, or a hash of the first instruction signature (or of its instruction identifier bits).

Since the first ISB predictor effectiveness measurement entry 202-1 has been instantiated (as described above) the search will be successful, resulting in access to the ISB predictor effectiveness measurement 2022 of that entry. In an aspect, the ISB prediction controller guide 106 may then provide the ISB predictor effectiveness measurement 2022 of the first ISB predictor effectiveness measurement entry 202-1 to the instruction signature aware optimization controller 112. In another aspect, the instruction signature aware optimization controller 112 may be provided with a data value predictor control threshold. The instruction signature aware optimization controller 112 can then control application of the data value predictor 102A, to the presently detected instance of the first instruction signature, by comparing the ISB predictor effectiveness measurement 2022 of the first ISB predictor effectiveness measurement entry 202-1 to the data value predictor control threshold. Examples of such comparison and control are described in greater detail later.

Control of application of the data value predictor 102A to instances of the second instruction signature can be performed identically, except that the instruction signature aware optimization controller 112 is provided with the ISB predictor effectiveness measurement 2022 of the second ISB predictor effectiveness measurement entry 202-2.

For purposes of description, it will be assumed that a data value predictor control threshold of 7% is provided to the instruction signature aware dynamic optimization controller 112. It will also be assumed that the instruction signature aware dynamic optimization controller 112 is configured to apply an enable/disable control to the data value predictor 102A. The numeral value 100 adjustments of the ISB predictor effectiveness measurement 2022 of the first ISB predictor effectiveness measurement entry 202-1 resulted in an adjusted value of 5%, as described above. The numeral value 150 adjustments of the ISB predictor effectiveness measurement 2022 of the second ISB predictor effectiveness measurement entry 202-2 resulted in an adjusted value of approximately 18.5%, as also described above. Assuming the example data value predictor control threshold of 7%, at respective times during the numeral value 250 detections of the first instruction signature and the second instruction signature, application of the data value predictor 102A to the second instruction signature will be disabled. However, application of the data value predictor 102A to the first instruction will remain enabled.

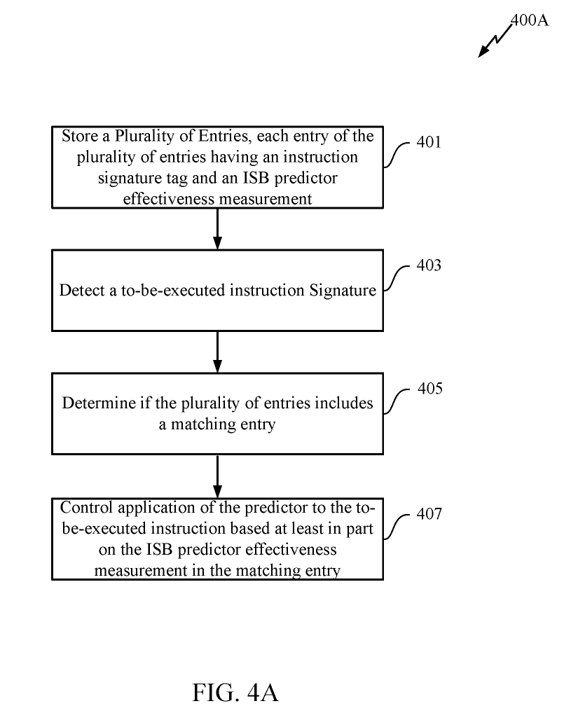

FIG. 3 is a diagram of an ISB control of a predictor in an ISB dynamically tuned speculative optimization process according to various aspects, as described above. Referring to FIG. 3, the control can comprise comparing the ISB predictor effectiveness measurement 2022 to a provided threshold, in this instance 5%.

As described above, the total numeral value 250 detections of the first instruction signature and the second instruction signature, and corresponding numeral value 250 adjustments of the predictor effectiveness measurement maintained by the predictor effectiveness indicator 104 resulted in an adjusted value of 13.2%. Therefore, if the predictor effectiveness indicator 104 were used to control the data value predictor 102A, its application would be disabled for both the first instruction signature and the second instruction signature. It can therefore be understood that instruction signature specific control of the data value predictor 102A, as provided by the disclosed aspects, can provide, among other features and benefits, ISB dynamically tuned speculative optimization. Additionally, although discussion of FIGS. 2 and 3 has been directed to data value prediction, one skilled in the art will readily understand that the same concepts apply to branch prediction and prefetch prediction, and can adapt the teachings herein to those types of prediction without undue experimentation.

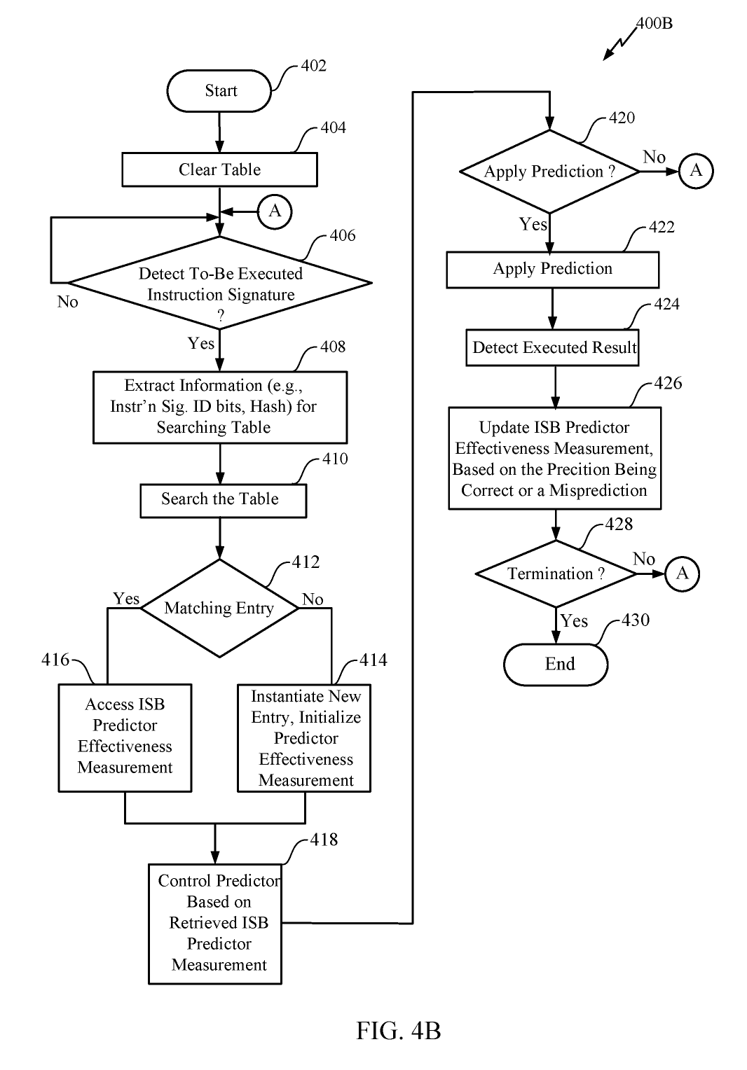

FIG. 4A is a diagram of an example flow 400A of operations in a process of ISB dynamically tuned speculative optimization, according to various aspects. As shown in FIG. 4A, block 401 includes storing a plurality of entries. In one example, storing the plurality of entries may include creating one or more ISB predictor effectiveness entries (e.g., 202-1, 202-1, . . . 202-R of FIG. 2) in an ISB predictor effectiveness entry table (e.g., table 108 of FIG. 1 and/or ISB predictor effectiveness entry table 200 of FIG. 2). Each entry of the plurality of entries may include an instruction signature tag (e.g., IS Sig. Tag 2020 of FIG. 2) and an ISB predictor effectiveness measurement (e.g., ISB PE Measurement 2022). As mentioned above, the instruction signature tag corresponds to an instruction signature and the ISB predictor effectiveness measurement is based, at least in part, on an effectiveness of a predictor when applied to the instruction signature.

Next, in block 403, a to-be-executed instruction signature is detected. In process block 405, it is then determined if the plurality of entries includes a matching entry. In one aspect, a matching entry is one that has an instruction signature tag corresponding to the to-be-executed instruction signature. Upon determining that the plurality of entries includes the matching entry, block 407 includes controlling an application of the predictor to the to-be-executed instruction signature, based at least in part on the ISB predictor effectiveness measurement in the matching entry. Details regarding the example specific operations of the blocks 401-407 are described in further detail below with reference to flow 400B of FIG. 4B.

FIG. 4B shows one flow 400B, of example operations in a process for dynamic tuning instruction signature based (ISB) speculation optimization, according to various aspects. Flow 400B is one possible implementation of flow 400A of FIG. 4A. One or more illustrative examples of each operation in the flow 400B will be described in reference to FIG. 1. It will be understood that such description is to avoid unnecessary complications of describing other example apparatuses, and not intended to, and does not limit any aspect to the FIG. 1 example.

Referring to FIG. 4B, the flow 400B may arbitrarily start at 402, and proceed to 404, and perform operations of clearing an ISB predictor effectiveness table, such as the ISB predictor effectiveness entry table 200 described in reference to FIG. 2. After clearing the ISB predictor effectiveness table at 404, the flow 400B may proceed to 406 and wait for detection. Detection can be, for example, the event of detecting the first instance of a program instruction having the first instruction signature or the second instruction signature. Upon detecting a to-be-executed instruction signature at 406, the flow 400B may proceed to 408 and apply operations to extract from the to-be-executed instruction signature information for mapping to, and searching the ISB predictor effectiveness table. As an example, if the instruction signature tags 2020 are a hash of all bits of, or certain portions of the opcode, operations at 408 can include a generating a hash of the instruction signature, instruction signature ID bits or other identified at 408,

After operations at 408, the flow 400B can proceed to 410 and apply operations of searching the ISB predictor effectiveness entry table 200 for a matching ISB predictor effectiveness measurement entry 202. If a matching ISB predictor effectiveness measurement entry is not found then, as shown by the decision block 412, the flow 400B may proceed to 414 and instantiate a new entry in the ISB predictor effectiveness table. Operations at 414 may include, for example, instantiating an ISB predictor effectiveness measurement entry 202 as described in reference to FIG. 2.

If matching ISB predictor effectiveness measurement entry 202 is found, the flow 400 can proceed to 416 and perform operations of accessing the ISB predictor effectiveness measurement, e.g., the ISB predictor effectiveness measurement 2022, held in that matching entry. The flow 400B may then proceed to 418 and perform operations of controlling the predictor (whether for data value, branch or pre-fetch prediction) ISB based on that predictor effectiveness measurement. Example operations at 418 can include the instruction signature aware dynamic optimization controller 112 comparing the ISB predictor effectiveness measurement to a provided predictor control threshold, and then selectively enabling, disabling, or throttling the predictor based on the comparison, as described above. In an aspect, operations at 418 can include generating a random number and comparing the random number to a threshold that can be set according to the ISB predictor effectiveness measurement value retrieved at 414.

Referring to FIG. 4B, as shown by decision block 420, if the control at operations at 418 disables or throttles applying the predictor to the instruction signature, the flow 400B returns to 406. However, in block 420, if the control at operations at 418 enables applying the predictor to the instruction signature, the flow 400B may proceed to 422 and perform operations of applying the predictor detecting the actual executed result of the to-be-executed instruction whose result was predicted at 422. The flow 400B can then proceed to 424 to detect the executed result, and then to 426 to update the ISB predictor effectiveness measurement 4022 associated with the prediction, based on a comparing the predicted execution result to the detected execution result. The flow 400B can then proceed to 428 and, if a termination (e.g., end of the program) is applied to detected, can terminate at 430. The flow 400B can otherwise return to 406.

Table 1 shows one example training program comprising a sequence of seven program instructions, each comprising a register load instruction and its destination register. Referring to FIG. 2,

TABLE 1

| Pro- | | | | |
|---|---|---|---|---|
| gram. | | | | |
| Inst. | | | | Instruction |
| No. | Assembly Code | | Opcode | Signature |
| i1 | 0 × | LDR R0, 0(R1) | LDR [symbol] 0101 | LDR0 [symbol] 010100 |
| | 8000 | . . . | | |
| i2 | 0 × | LDRB R1, 0(R3) | LDRB [symbol] 0100 | LDRB1 [symbol] 010001 |
| | 8040 | . . . | | |
| i3 | 0 × | LDRH R2, 0(R4) | LDRH [symbol] 1101 | LDRH2 [symbol] 110110 |
| | 8060 | . . . | | |
| i4 | 0 × | LDRB R1, 0(R1) | LDRB [symbol] 0100 | LDRB1 [symbol] 010001 |
| | 8080 | . . . | | |
| i5 | 0 × | LDR R3, 0(R2) | LDR [symbol] 0101 | LDR3 [symbol] 010111 |
| | 80A0 | . . . | | |
| i6 | 0 × | LDR R0, 0(R1) | LDR [symbol] 0101 | LDR0 [symbol] 010100 |
| | 8000 | . . . | | |
| i7 | 0 × | LDRB R1, 0(R1) | LDRB [symbol] 0100 | LDRB1 [symbol] 010001 |
| | 8080 | | | |

The first (leftmost) column, labeled “Program Inst. So.,” shows program instruction numbers, namely, i1,” “i2,” “i3,” “i7.” The program instruction numbers can be, for example, conventional program count (PC) values. The second column, labeled “Assembly Code,” shows an assembly code for the program instruction associated with each of the program instruction numbers. The assembly code includes three sub-types of register load instructions. One is represented as “LDR,” is a load register instruction. Another is represented as “LDRH,” will be understood to be a “load register with memory half-word,” with an address offset. The remaining one of the three types, represented as “LDRB,” will be understood to be a “load register byte,” using another address offset.

As shown by the fourth column, “Instruction Signature,” Table 1 program instructions comprise four different instruction signatures. More specifically, program instructions it and i6 are instances of the instruction signature “LDR0→4010100.” This can be a first instruction signature. Program instructions i2, i4 and i7 are instances of another instruction signature, which is LDRB1→010001.” This can be a second instruction signature. Program instruction i3 is an instance of an instruction signature “LDRH2→110110.” This can be a third instruction signature. Program instruction i5 is an instance of another instruction signature, “LDRH2→010111.” This can be a fourth instruction signature.

Table 2 shows simulation results of a dynamic ISB training of a predictor, for example the data value predictor 102A, for the four instruction signatures described above.

TABLE 2

| | ISB Predictor Effectiveness |
|---|---|
| | Measurements |
| Instruction Signature | (misprediction rate) |
| LDR0 [symbol] 010100 | 7% |
| LDRB1 [symbol] 010001 | 2% |
| LDRH2 [symbol] 110110 | 4% |
| LDR3 [symbol] 010111 | 10% |

The Table 2 simulation results may be obtained, for example, by running a dynamic ISB training according to the FIG. 4B flow 400B, using the Table 1 sequence of program instructions as a training program. As shown, the respective ISB predictor effectiveness measurements, in terms of misprediction rate, of 7%, 2%, 4% and 10%.

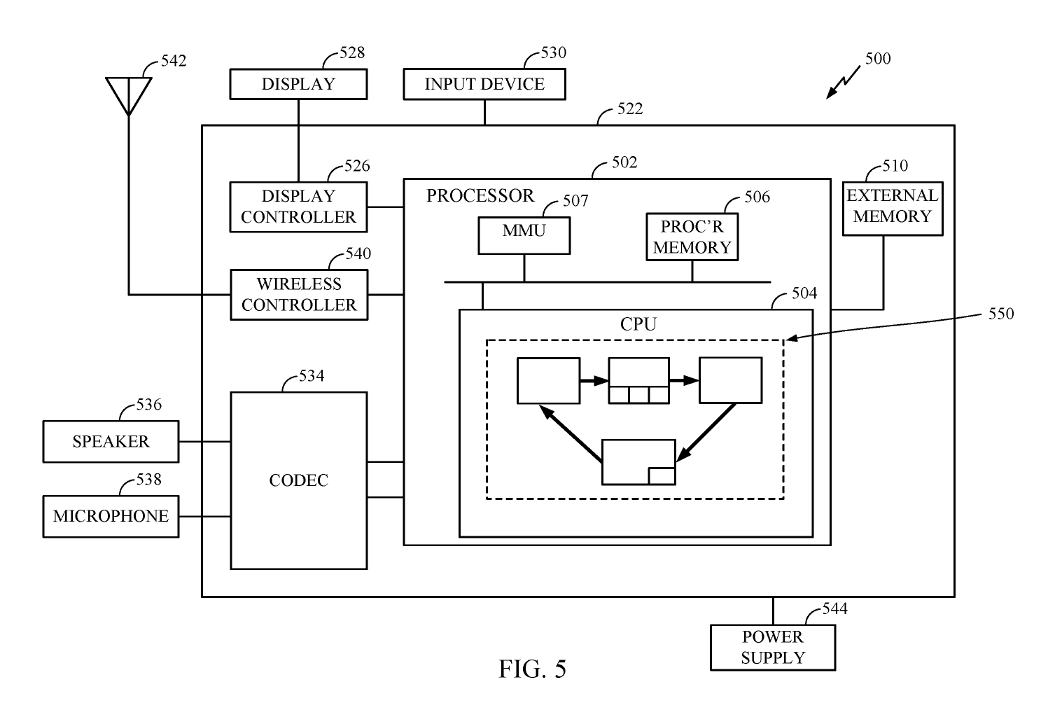

FIG. 5 shows a block diagram of a wireless device that is configured according to exemplary aspects is depicted and generally designated as wireless device 500. Referring to FIG. 5, wireless device 500 includes processor 502 having a CPU 504, a processor memory 506 and system memory management units (SMMU) 507, interconnected by a system bus (visible in FIG. 5, but not separately labeled). The processor 502 includes an ISB dynamically tunable speculation system 550 that may be configured as the FIG. 1 ISB dynamically tunable speculation system 100.

Wireless device 500 may be configured to perform the various methods described in reference to FIGS. 2-4B, and may be further be configured to execute instructions retrieved from processor memory 506, or external memory 510 in order to perform any of the methods described in reference to FIGS. 2-4B.

FIG. 5 also shows display controller 526 that is coupled to processor 502 and to display 528. Coder/decoder (CODEC) 534 (e.g., an audio and/or voice CODEC) can be coupled to processor 502. Other components, such as wireless controller 540 (which may include a modem) are also illustrated. For example, speaker 536 and microphone 538 can be coupled to CODEC 534. FIG. 5 also indicates that wireless controller 540 can be coupled to wireless antenna 542. In a particular aspect, processor 502, display controller 526, processor memory 506, external memory 510, CODEC 534, and wireless controller 540 may be included in a system-in-package or system-on-chip device 522.

In a particular aspect, input device 530 and power supply 544 can be coupled to the system-on-chip device 522. Moreover, in a particular aspect, as illustrated in FIG. 5, display 528, input device 530, speaker 536, microphone 538, wireless antenna 542, and power supply 544 are external to the system-on-chip device 522. However, each of display 528, input device 530, speaker 536, microphone 538, wireless antenna 542, and power supply 544 can be coupled to a component of the system-on-chip device 522, such as an interface or a controller.

In one aspect, the processor memory 506 or the external memory 510, or both, may be configured as a non-transitory computer readable medium comprising code, which, when read and executed by a processor, such as the processor 502, cause the processor to store a plurality of entries, such as the ISB predictor effectiveness measurement entries 202 described in reference to FIG. 2, can include an ISB each including an instruction signature identifier and an ISB predictor effectiveness measurement, such as the instruction signature and the ISB predictor effectiveness measurement 2022. As described previously in this disclosure, the instruction signature identifier can be configured to identify an instruction signature, and the ISB predictor effectiveness measurement can be based, least in part, on an effectiveness of a predictor for the instruction signature. The code that may be stored, for example, in the processor memory 506 or the external memory 510, or both, which, when read and executed by a processor, such as the processor 502, cause the processor to detect a to-be-executed instruction signature, mapping to an entry among the plurality of entries, and determining said entry as a matching entry; and to control the predictor for said to-be-executed instruction, based at least in part on the ISB predictor effectiveness measurement in the matching entry.

In an aspect, the above-described aspects can configure the processor 502, the processor memory 506 or the external memory 510, or both, as a means for storing a plurality of entries, each of the entries including an instruction signature tag r and an ISB predictor effectiveness measurement, the instruction signature identifier being a mapping of an instruction signature, the ISB predictor effectiveness measurement indicating effectiveness of a predictor for the instruction, when the instruction is executed in accordance with the instruction signature, a means for detecting a to-be-executed instruction signature that matches the instruction signature tag of any entry among the plurality of entries, and determining said entry as a matching entry, and a means for controlling the predictor for said to-be-executed instruction, based at least in part on the ISB predictor effectiveness measurement in said matching entry.

It will be understood that the ISB dynamically tunable speculation system 550 is not necessarily part of the processor 502 and, instead, may be distributed through other components of the wireless device 500.

It should also be noted that although FIG. 5 depicts a wireless communications device, processor 502, and its ISB dynamically tunable speculation system 550, may also be integrated into a set-top box, a music player, a video player, an entertainment unit, a navigation device, a personal digital assistant (PDA), a fixed location data unit, a server, a computer, a laptop, a tablet, a mobile phone, or other similar devices. These devices may or may not include wireless communication capabilities.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an implementation or practice according to one or more aspects can include a computer readable media embodying a method for dynamically tunable signature-based of speculative optimizations based on instruction signature, according to various aspects. Accordingly, the practices are not limited to illustrated examples. Instead, any means for performing the functionality described herein are included in the scope of practices and implementations contemplated by this disclosure.

While the foregoing disclosure shows illustrative implementations or practice according to one or more aspects, it should be noted that various changes and modifications could be made herein without departing from the scope of implementations, configurations, arrangements or practices according to one or more aspects, defined by the appended claims. The functions, steps and/or actions of the method claims in accordance with the concepts and aspects described herein need not be performed in any particular order. Furthermore, although elements of implementations, configurations, arrangements or practices according to one or more aspects may be described or claimed in the singular, the plural is contemplated unless limitation to the singular is explicitly stated.

What is claimed is:

1. A method for instruction signature based (ISB) speculative optimization, comprising:
storing a plurality of entries, each entry of the plurality of entries comprising an instruction signature tag and an ISB predictor effectiveness measurement, the instruction signature tag corresponding to an instruction signature, and the ISB predictor effectiveness measurement being based, least in part, on an effectiveness of a predictor when applied to the instruction signature;
detecting a to-be-executed instruction signature;
determining if the plurality of entries includes a matching entry, the matching entry having an instruction signature tag corresponding to the to-be-executed instruction signature; and
upon determining that the plurality of entries includes the matching entry, controlling an application of the predictor to the to-be-executed instruction signature, based at least in part on the ISB predictor effectiveness measurement in the matching entry.

2. The method of claim 1, wherein controlling the application of the predictor to the to-be-executed instruction includes selecting between enabling and disabling the predictor for the to-be-executed instruction, based at least in part, on the ISB predictor effectiveness measurement in the matching entry.

3. The method of claim 1, wherein controlling the application of the predictor to the to-be-executed instruction includes varying a throttling of the predictor for the to-be-executed instruction, based, at least in part, on the ISB predictor effectiveness measurement in the matching entry.

4. The method of claim 1, wherein the plurality of entries is stored in an ISB predictor effectiveness table, the method further comprising:
upon detecting the to-be-executed instruction signature, searching the ISB predictor effectiveness table for the matching entry; and
upon a result of the searching for the matching entry indicating no matching entry,
instantiating a new entry in the ISB predictor effectiveness table, the new entry in the ISB predictor effectiveness table having an entry instruction signature tag corresponding to the to-be-executed instruction signature.

5. The method of claim 4, further comprising, in association with instantiating the new entry, initializing the ISB predictor effectiveness measurement of the new entry to an initial value that enables a predictor.

6. The method of claim 1, wherein, for each entry of the plurality of entries, the instruction signature tag comprises a hash of at least a portion of the to-be-executed instruction signature corresponding to the instruction signature tag.

7. The method of claim 6, wherein determining if the plurality of entries includes a matching entry; comprises:
generating a checking hash, the checking hash being a hash of at least a portion of the to-be-executed instruction signature; and
detecting a match of at least a portion of the checking hash and the instruction signature tag of the matching entry.

8. The method of claim 1, wherein the instruction signature tag in each entry of the plurality of entries is a mapping of instruction signature identifier bits appended to an opcode of the instruction signature.

9. The method of claim 8, wherein the instruction signature identifier bits comprise bits of an opcode corresponding to the to-be-executed instruction signature.

10. The method of claim 9, wherein the instruction signature identifier bits comprise bits appended to the opcode for the instruction signature.

11. The method of claim 1, wherein the plurality of entries includes at least a first entry and a second entry, the first entry including a first instruction signature tag and a first ISB predictor effectiveness measurement, the second entry including a second instruction signature tag and a second ISB predictor effectiveness measurement, and
wherein the first instruction signature tag is a mapping of a first instruction signature, and the second instruction signature tag is a mapping of the second instruction signature.

12. The method of claim 11, the first instruction signature comprising opcode bits of a register load instruction and bits identifying a first target register, the second instruction signature comprising the opcode bits of the register load instruction and bits identifying a second target register.

13. The method of claim 12, the first instruction signature further comprising a first program counter value and the second instruction signature further comprising a second program counter value.

14. The method of claim 12, wherein the first ISB predictor effectiveness measurement has a first value and the second ISB predictor effectiveness measurement has a second value, the second value being different than the first value.

15. The method of claim 1, wherein the predictor for the to-be-executed instruction signature is a data value predictor.

16. The method of claim 1, further comprising:
generating a predicted execution result of the to-be-executed instruction signature;
detecting whether the predicted execution result is correct or a misprediction;
and
updating the ISB predictor effectiveness measurement of the matching entry, based on a result of detecting whether the predicted result is correct or a misprediction.

17. The method of claim 16, wherein detecting whether the predicted result is correct comprises:
executing the to-be-executed instruction signature;
comparing a result of the executing the to-be-executed instruction signature to the predicted result; and
based on a result of the comparing, determining whether the predicted result is correct or a misprediction.

18. An apparatus for instruction signature based (ISB) speculative optimization, comprising:
means for storing a plurality of entries, each entry of the plurality of entries including an instruction signature tag and an ISB predictor effectiveness measurement, the instruction signature tag being a mapping of an instruction signature, and the ISB predictor effectiveness measurement indicating an effectiveness of a predictor when applied to the instruction signature;
means for detecting a to-be-executed instruction signature having a matching entry among the plurality of entries; and
means for controlling a predictor as applied to the to-be-executed instruction signature, based at least in part on the ISB predictor effectiveness measurement in the matching entry.

19. The apparatus of claim 18, further comprising:
means for generating a predicted execution result of the to-be-executed instruction signature;
means for detecting whether the predicted execution result is correct or a misprediction; and
means for updating the ISB predictor effectiveness measurement of the matching entry, based on a result of detecting whether the predicted execution result is correct or a misprediction.

20. A non-transitory computer readable medium comprising code, which, when read and executed by a processor, causes the processor to
store a plurality of entries, each entry of the plurality of entries including an instruction signature tag and an ISB predictor effectiveness measurement, the instruction signature tag corresponding to an instruction signature, and the ISB predictor effectiveness measurement indicating an effectiveness of a predictor when applied to the instruction signature;
detect a to-be-executed instruction signature;
determine if the plurality of entries includes a matching entry, the matching entry having an instruction signature tag corresponding to the to-be-executed instruction signature; and
control an application of the predictor to the to-be-executed instruction signature, based at least in part on the ISB predictor effectiveness measurement in the matching entry.

21. The non-transitory computer readable medium of claim 20, wherein the code, when read by the processor, further causes the processor to:
generate a predicted execution result of the to-be-executed instruction;
detect whether the predicted execution result is correct or a misprediction; and
update the ISB predictor effectiveness measurement of the matching entry, based on a result of detecting whether the predicted execution result is correct or a misprediction.

22. The non-transitory computer readable medium of claim 20, wherein the code, when read by the processor, further causes the processor to:
instantiate a new entry upon detecting no matching entry for the to-be-executed instruction signature, the new entry having an entry instruction signature tag corresponding to the to-be-executed instruction signature.

23. The non-transitory computer readable medium of claim 22, wherein the code, when read by the processor, further causes the processor to:
initialize the ISB predictor effectiveness measurement of the new entry to an initial value that enables a predictor.

24. The non-transitory computer readable medium of claim 22, wherein, for each entry, the instruction signature tag comprises a hash of at least a portion of the to-be-executed instruction signature corresponding to by the instruction signature tag.

25. The non-transitory computer readable medium of claim 24, wherein determining if the entries include a matching entry comprises:
generating a checking hash, the checking hash being a hash of at least a portion of the to-be-executed instruction signature; and
detecting a match of at least a portion of the checking hash and the instruction signature tag of the matching entry.

26. An apparatus for instruction signature based (ISB) speculative optimization, comprising;
a processor; and
a memory coupled to the processor,
the processor being configured to
store a plurality of entries, each entry of the plurality of entries including an instruction signature tag and an ISB predictor effectiveness measurement, the instruction signature tag corresponding to an instruction signature, and the ISB predictor effectiveness measurement indicating an effectiveness of a predictor when applied to the instruction signature,
detect a to-be-executed instruction signature,
determine if any of the plurality of entries is a matching entry for the to-be-executed instruction signature, and
control an application of the predictor to the to-be-executed instruction signature, based at least in part on the ISB predictor effectiveness measurement in the matching entry.

27. The apparatus of claim 26, the processor being further configured to:
generate a predicted execution result for the to-be-executed instruction signature;
detect whether the predicted execution result is correct or a misprediction; and
update the ISB predictor effectiveness measurement of the matching entry, based on a result of detecting whether the predicted result is correct or a misprediction.

28. The apparatus of claim 27, wherein detecting whether the predicted result is correct comprises:
executing the to-be-executed instruction signature;
comparing a result of the executing the to-be-executed instruction signature to the predicted execution result; and
based on a result of the comparing, determining whether the predicted execution result is correct or a misprediction.

29. The apparatus of claim 28, wherein controlling the application of the predictor to the to-be-executed instruction signature includes selecting between enabling and disabling the predictor for the to-be-executed instruction signature, based at least in part, on the ISB predictor effectiveness measurement in the matching entry.

30. The apparatus of claim 26, wherein the plurality of entries is stored in an ISB predictor effectiveness table of the memory, the processor being further configured to:
upon detecting the to-be-executed instruction signature, searching the ISB predictor effectiveness table for the matching entry; and
upon a result of the searching for the matching entry indicating no matching entry,
instantiating a new entry in the ISB predictor effectiveness table, the new entry in the ISB predictor effectiveness table having an entry instruction signature tag corresponding to the to-be-executed instruction signature.
